(19) United States
(12) Patent Application Publication
(10) Pub. No.: US 2008/0100466 A1
(43) Pub. Date: May 1, 2008

(54) System For Monitoring And Signalling Users Presence In A Spatial Region And Partner Search Device

(76) Inventor: Domenico Lopreiato, Stefanaconi (Vibo Valentia) (IT)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/630,194

(22) PCT Filed: Oct. 28, 2004
(86) PCT No.: PCT/IB04/03285

§ 371 Date: Aug. 9, 2007

(30) Foreign Application Priority Data
Oct. 30, 2003 (IT) TO2003A000852

(51) Int. Cl. H04L 12/56; G08B 21/00; G08B 5/36; H04M 1/725; H04L 29/08

(52) U.S. Cl. 340/686.1

(57) ABSTRACT

A system for monitoring and signaling users' presence in a spatial region (S), comprising a plurality of terminals (10, 10′) associated to said users, said terminals (10, 10′) comprising wireless transreceiving means (32) for transmitting and receiving in said spatial region (S) signals comprising at least a characteristic portion (ft, f′t; PK, PK′) associated to a users' characteristic piece of information (P, P′), and modules (31) configured so as to manage and store said users' characteristic information (P, P′) and to transit said characteristic information (P, P′) via transreceiving means (32). According to the invention, said transreceiving means (32) are configured so as to transmit at short ray (R) in broadcasting mode on said spatial region (S), and said terminals (10, 10′) further comprise means (11, 16, 33, 35) for signaling the reception of said signal characteristic portion(f′t; PK′) transmitted at short ray (R) by a second terminal (10′) belonging to said plurality of terminals (10, 10′) and in said special region (S).

The present invention relates to a system for monitoring and signaling users' presence in a spatial region, comprising a plurality of terminals associated to said users, said terminals comprising wireless transreceiving means for transmitting and receiving in said spatial region signals comprising at least a characteristic portion associated to a user's characteristic information, and modules configured so as to manage and store said user's characteristic information and to transmit said characteristic information via said transreceiving means.

There is often the need to identify and contact a person when one however finds himself in large or very crowded places, such as a department store, a square or a discotheque, which makes identification difficult. Contact is even more difficult if said person is unknown, or if a person with peculiar features is being searched for.

Identification systems based on communication terminals used by people that need contact have been proposed.

In particular, international patent application no. WO 02/21864 discloses a system for putting into communication two terminals by means of a mobile network provided with a central unit. Said terminals should contain a user profile and communication should take place when said profiles correspond. More specifically, the terminals should receive information containing also the position of the other terminal. In particular, the user profile should store information concerning personal preferences on various topics.

A similar solution, however, requires the use of an expensive and complex mobile phone network and therefore the intervention of an operator working in the field, who can implement said functions into his/her systems.

The present invention aims at achieving a simple system for monitoring and signaling a user's presence in a spatial region, which does not require the integration into telecommunication networks, in particular mobile networks.

According to the present invention, said aim is achieved thanks to a system for monitoring and signaling users' presence in a spatial region, and to a corresponding method for monitoring and signaling users' presence in a spatial region, having the features specifically referred to in the annexed claims.

The invention will now be described with reference to the accompanying drawings, provided by mere way of non-limiting example, in which:

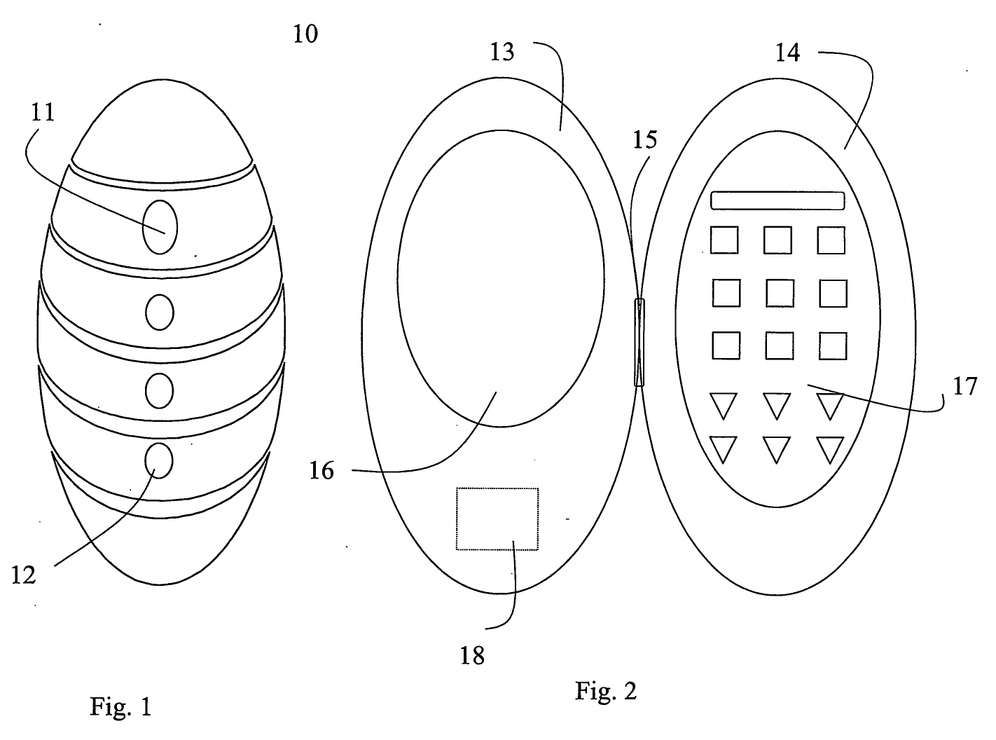

FIG. 1 is a view of the terminal of the proposed system in closed configuration;

FIG. 2 is a view of the terminal in FIG. 1 in open configuration;

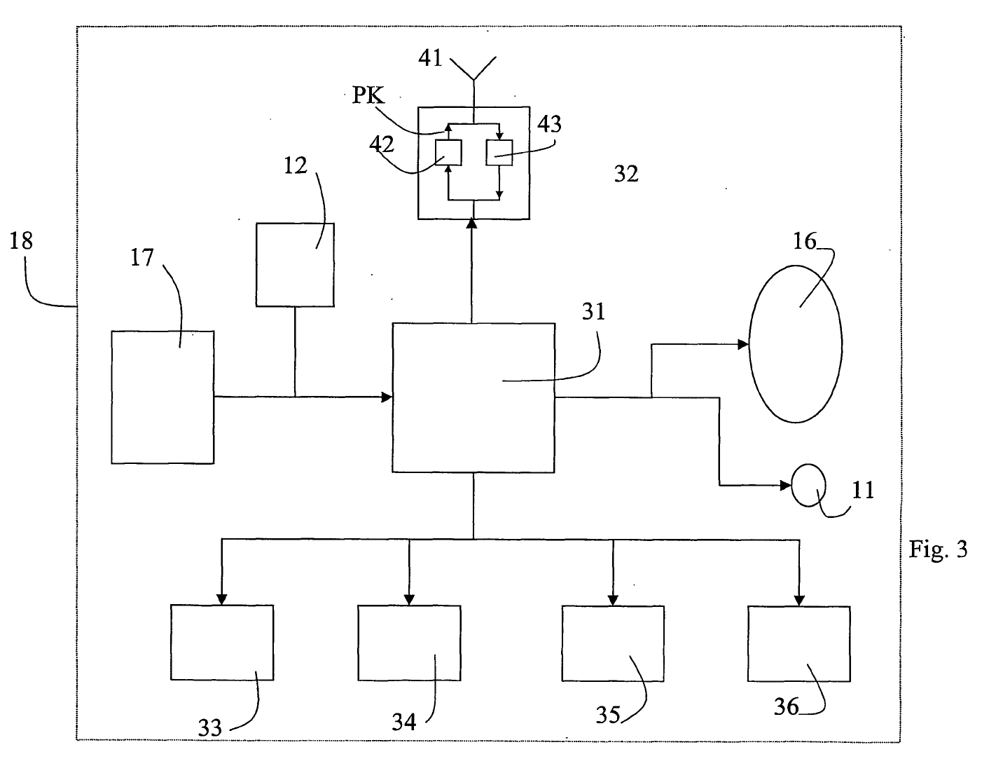

FIG. 3 is a layout block diagram of a control circuit of the terminal in FIG. 1;

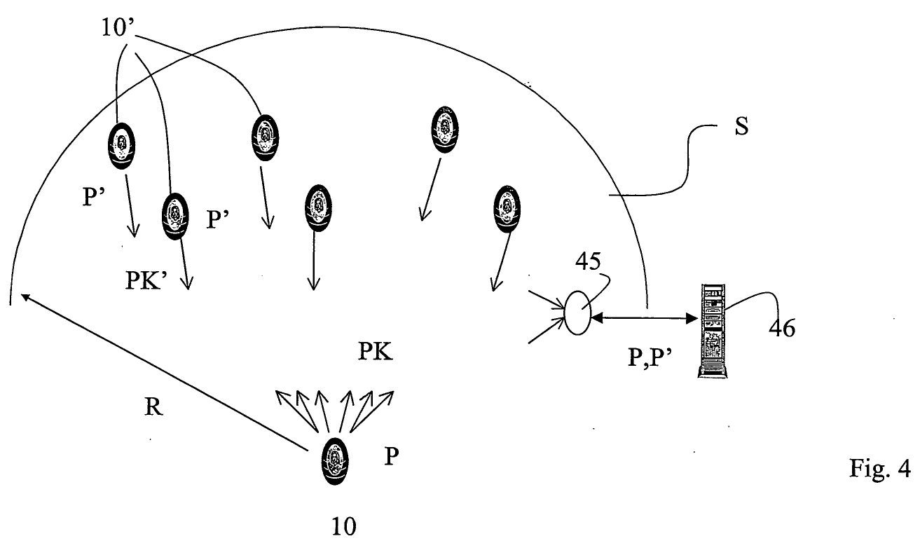

FIG. 4 is a layout diagram of the system according to the invention;

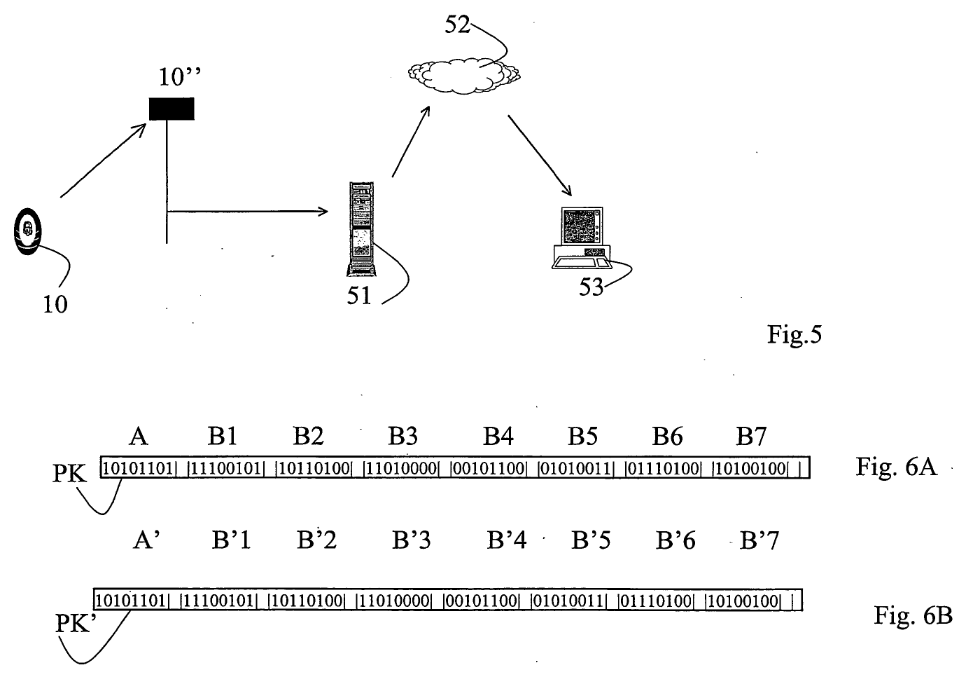

FIG. 5 is a layout diagram of a variant to the system in FIG. 4;

FIGS. 6A and 6B are diagrams of signal formats used by the control circuit in FIG. 3.

FIG. 1 shows a personal monitoring and signaling terminal according to the invention, globally referred to with reference number 10. Said personal terminal 10 in FIG. 1 is showed in an outer view in closed configuration, and comprises outside a signaling light 11 and outer pushbuttons 12 for controlling personal terminal 10 when it is closed.

In FIG. 2 personal terminal 10 is showed in open configuration, and it is thus made up of a first half-body 13 and of a second half-body 14, joined by a hinge 15. First half-body 13 comprises a display 16, whereas second half-body 14 comprises an alphanumeric keyboard 17. First half-body 13 further comprises inside a control circuit 18, represented by a hatched line.

FIG. 3 represents a block diagram of said control circuit 18, which comprises a central control unit 31, basically made up of a micro-controller provided with signal inputs and outputs, and with a suitable RAM and ROM memory. Said central control unit 31 receives control signals as input from alphanumeric keyboard 17 or from outer pushbuttons 12, whereas as output it controls display 16 and signaling light 11. Moreover, said central control unit 31 is associated to a vibration signaling module 33, a supply battery 34, an audio module 35 and a USB-type access port 36, so as to enable recharging of battery 34 and cable communication from outside with central control unit 31, for instance for interfacing personal terminal 10 with a computer.

Central control unit 31 is therefore electrically associated to a transreceiving module 32.

Said transreceiving module 32 comprises an antenna 41 associated in parallel to a transmitting and coding module 42 and to a receiving and decoding module 43. Transmitting and coding module 42 is configured so as to transmit a numeric signal containing a characteristic code. To said characteristic code, which is coded with a binary coding on a given number of bits, 8 for instance, further portions of binary code can be added, so as to identify the user's preferences, until a user profile P is obtained, said profile containing preferences that can be varied according to one's taste and the characteristic code constituting an identifier for the user, which cannot be changed.

Said user profile P, thus modified according to a binary mode, can be transmitted in a numeric packet PK via a digital short-range communication protocol.

Thus, the transmitting and coding module 42 operates under the control of central control unit 31, which provides the values of the fields of packet PK to be coded according to a binary mode, by processing information contained in its memory, in particular in user profile P stored therein. In a preferred. embodiment, said correspondence between profile P and fields of packet PK is obtained by means of a look-up table stored in control unit 31, but any kind of diagram setting a relation between a set of available binary fields and groups of information in user profile P can be used.

Said user profile P comprises information on user's preferences, for instance musical tastes or favorite sports. In the simplest version, for instance, for each different preference, for instance “favorite sport is soccer”, a characteristic value is associated to a field of packet PK.

Receiving and decoding module 43, on the contrary, receives signals transmitted by further personal terminals 10′ similar to the personal terminal 10, decodes them and provides the result of said decoding operation to unit 31. Further personal terminals 10′, shown in FIG. 4, will transmit in their turn digital signals comprising packets PK′, generally differing from one another in their content. Further personal terminals 10′, as can be inferred from FIG. 4, are in a spatial region S within a radius R of distance from personal terminal 10′.

Receiving and decoding module 43 can also carry out a search of packets PK′ or their particular fields among those received, so as to identify specific ones among further terminals 10′.

According to the proposed monitoring and signaling system, transmitting and coding module 42 and receiving and decoding module 43 are basically active and continuous, irradiating signals containing packet PK and receiving signals containing packets PK′ from further terminals 10′ placed inside spatial region S.

According to a first operating mode, when packet PK′ of a signal received in personal terminal 10 from a further terminal 10′ placed inside spatial region S contains a piece of information corresponding to one or more pieces of information of profile P stored in the memory of central control unit 31, a presence signaling is activated through vibration signaling module 33 or audio module 35 or light indicator 11.

Personal terminal 10 can be programmed with profiles P through a computer, using USB-type access port 36.

Transreceiving module 32 operates in short-range broadcasting mode, on distances basically not above one hundred meters, so that said signaling of presence of a twin terminal with respect to profile P means that such a presence is within said distance.

Therefore, personal terminal 10 is designed to detect the presence within a given distance of an homologous terminal containing a profile P′ corresponding partly or wholly to profile P of one's own user, or simply to a profile of preferences being searched for, and to set up, if necessary, a communication automatically. As a matter of fact, personal terminal 10 can be equipped so as to operate as a normal radio transceiver with suitable microphone and loudspeaker, using transreceiving module 32 for communication.

In other words, profile P′ as well can simply contain the information “favorite sport is soccer” and therefore activate signaling on other personal terminals 10 present in the surrounding spatial region S and searching for profiles containing the information “favorite sport is soccer”.

Beyond this first operating mode, referred to as “profile mode”, other operating modes of personal terminal 10 are possible.

For instance, in an operating mode referred to as “twin mode”, transreceiving module 32 under the control of central control unit 31 can be configured so as to select a packet PK′ containing a particular characteristic code identifying a user to which it might want to be connected. In other words, personal terminal 10 is set through actuating means such as alphanumeric keyboard 17 or outer pushbuttons 12 for signaling in a particular and characteristic manner the reception of packet PK′ of a second specific personal terminal 10′ to which it might want to be connected. Connection is mutual, thus also the other terminal 10′ will arrange, for instance by pushing the same actuating means for a given time, to signal in a particular and characteristic manner the reception of packet PK of terminal 10′. Said connection therefore results in that, when personal terminal 10 and second personal terminal 10′, connected to one another, are in the same spatial region S, the presence of said twin terminal is signaled on both personal terminals 10 and 10′ by means of a characteristic audiovisual signaling identifying the twin terminal, for instance by means of a light with a characteristic color emitted by the signaling light 11. Said connection condition can last for a limited period of time, for instance some days.

Said operating mode thus enables to signal the presence of a particular user one might want to identify in a crowd for instance.

In a further operating mode, referred to as “general mode”, personal terminal 10 can be set so as to activate when in its range of action there is any other personal terminal 10′ of the same type, even though not associated to a profile and therefore to a packet PK′ in some corresponding manner. In this case personal terminal 10 can transmit its user profile P or receive profile P′ from each of the other personal terminals 10′ present in spatial region S, thus becoming the terminal of a short-range network in broadcasting mode.

Profile P′ received by personal terminal 10 can be stored in the memory of central control unit 31 or in other memory resources available in personal terminal 10. In particular, personal terminal 10 can be integrated into a terminal of a mobile or cellular telecommunication network, whose hardware resources it can exploit or share. In particular, personal terminal 10 can exploit memory resources of the SIM card present in the mobile communication terminal. By means of access port 36 personal terminal 10 can then be connected to a processing personal computer and said profiles stored in personal terminal 10 can be filed.

In the “general mode” personal terminal 10 can also send a profile or message to all personal terminals 10′ which at that time fall within its range of action, i.e. in spatial region S, or only to terminals corresponding as far as profile P is concerned, or to those connected in “twin mode”, and said terminals can re-transmit the signal thus widening the covered area. Advantageously, said mode would enable, in places with many users such as discotheques, concerts, walks, city centers, holiday resorts, parks, to broadcast a message rapidly with the possibility to select concerned users through profile P or connection in “twin mode”.

FIG. 6A and FIG. 6B show diagrams of numeric packets representing profiles P and P′ in a digital short-ray connection.

In FIG. 6A PK refers to a numeric packet comprising 8 fields made up of 8 bits each, and namely:
a characteristic field A, i.e. a field concerning the “characteristic” numeric code: each personal terminal 10 has a factory setting with a value of 8 bit in characteristic field A, which cannot be changed and which thus distinguishes it from all other terminals of the same type.
profile fields B1, . . . , B7, i.e. fields concerning profile: they change according to selected preferences, in a predefined list for instance, which can correspond to the aforesaid look-up table for instance.

A non-limiting example of the content of said predefined list of preferences can be the following:

Terminal A: 10110100

B1 music band: depeche mode

B2 team: juventus

B3 passion: cinema

B4 holiday: tropea

B5 sex: male

B6 job: student

B7 hobby and sport: volley

Contact: tricky88@lop-web.net

Personal terminal 10 transmits the codified numeric information in packet PK at regular intervals or with a search function in covered spatial region S.

A further terminal 10′ will transmit a further packet PK′ having the same numeric format, which is shown in FIG. 6B and comprises a characteristic field A′ and corresponding profile fields B1′, . . . , B7′.

Each of the two terminals 10 and 10′ will obviously be enabled to receive and decode numeric packets PK and PK′.

There is thus a fixed field, i.e. characteristic field A, and fields, i.e. fields B . . . B7, which can be modulated by the user.

Coupling and/or transmission of further data between the two terminals 10 and 10′ occurs if:
one among fields B1 . . . B7 corresponds to one among fields B1′ . . . B7′: this is coupling by affinity characterizing the “profile mode”, the presence of homologous fields among profile fields reveals the same choice in the list of profile characteristics;
characteristic field A is “coupled” to characteristic field A′: this is coupling due to “twin mode” thanks to a previous agreement between two users who by mutual consent agree during reception each on the characteristic numeric code of the other one. This adjustment is active for a given period, 15 days for instance, and then disappears if connection is not renewed.

Beyond the two modes described above, a personal terminal 10′ can then be detected—whatever the content of its packet PK′—in the “general mode”.

As far as its transreceiving short-range enables it, a personal terminal 10 can further send a piece of information:
to the other agreeing terminals 10′ (characteristic field A, twin mode);
to the other similar terminals 10′ (profile fields B1 . . . B7, profile mode);
all similar terminals 10′ (profile fields B1 . . . B7, profile mode).

According to an alternative embodiment, transreceiving module 32 can operate in analog mode and comprise a transmitting module operating at a transmission frequency ft, which is a characteristic frequency of personal terminal 10. The value of said characteristic frequency ft is generally function of a user profile P stored in control unit 31, in particular of the characteristic code identifying the user. In other words, the transmitting module operates under the control of said central control unit 31, which sets the value of characteristic frequency ft by processing information contained in a profile P of the user. In a preferred embodiment, said correspondence between profile P and characteristic frequency ft is obtained by means of a look-up table stored in control unit 31, but any kind of diagram setting a relation between a set of available frequencies and groups of information in user profile P can be used.

The receiving module, on the contrary, receives signals transmitted by further personal terminals 10′ wholly similar to personal terminal 10, operating in reception on a band B around characteristic frequency ft. Said further personal terminals 10′, shown in FIG. 4, will transmit in their turn with their own characteristic frequencies f′t, generally differing from one another.

The receiving module can also carry out a frequency scan in reception in band B around transmission frequency ft in order to identify signals transmitted in the band of personal terminal 10.

It should be pointed out that if the transmitting module and the receiving module operate via characteristic frequencies instead of numeric signals, it is possible anyhow to modulate in time different frequencies, i.e. to transmit signals with different values of frequency in different periods of time, applying basically the same division as the one made via characteristic fields A and profile fields B1 . . . B7 in packets PK in the digital case.

According to a further aspect of the invention, public access terminals can be provided for, referred to with number 45 in FIG. 4, which are equipped with transreceiving modules 32 but are further associated to memory means containing databases with file function, in computers 46 for instance. Said terminals 45 are placed in public access places, so as to enable downloading of stored profiles from personal terminal 10 or searches among filed profiles. A personal computer can act as public file into which profiles can be downloaded and users having given characteristics can be searched for. Said public access terminal 45 acting as file can also be designed to evaluate the affinity between different profiles.

More specifically, said public access terminals 45 are designed to contain user data and profile, downloaded by said users by getting near public access terminal 45 with their own personal terminal 10. Said operation can be automatic or require authorization: the “general mode” could be selected and one's own data could be downloaded automatically into the local file when one is near, or from the site, connected to said files, in which one logs in and agrees to share one's own data with others' data.

A user can get with his/her own personal terminal 10 near one of these public access terminals 45 acting as local files and makes a search with a keyword,—depeche mode—for instance, in order to see whether there are any fans who have logged in and/or who will take part to a future concert. Profiles and data corresponding to said search can then be downloaded into one's own terminal 10.

Said public access terminals 45 can provide a common platform where personal terminals 10 which at that time are in the concerned spatial region can dialogue with free messages or messages that can be displayed only on specific personal terminals 10. Said public access terminals 45 can be moved and installed in a place frequented by users equipped with personal terminals 10, such as concerts or sales outlets.

Said function of common platform of public access terminals 45 is anyhow an additional function since personal terminals 10 and 10′ define a monitoring and signaling network with short-range broadcasting, which does not require per, se central units managing communication traffic.

As was already mentioned, personal terminal 10 can be integrated into a mobile phone terminal, with which it can share both microprocessor and memory resources and parts of transreceiving circuit. For instance, the radio frequency transceiver for Blueetooth channel, which mobile phones are currently equipped with, can be used for transmitting also or as an alternative a broadcasting channel.

According to a further embodiment, disclosed with reference to FIG. 5, fixed terminals 10″ operating according to the same principle as personal terminals 10 and 10′, i.e. they can detect a characteristic profile through the reception of a characteristic frequency, can be distributed on a given territory, for instance on motorway toll-booths. Fixed terminals 10″ communicate via a suitable communication network, a UMTS mobile network for instance, with a server 51, which stores users' passages by detecting their personal terminal 10 and their profiles P.

Server 51 can be accessed via Internet 52 and a personal computer 53, in order to verify whether the personal terminal 10 of a person whose position should be checked has passed through a given point in which a fixed terminal 10″ has been arranged. For said mode personal terminal 10 can also be installed on board a motor car.

The solution just described above enables to obtain great advantages with respect to known solutions.

The system according to the invention advantageously allows for monitoring and signaling the presence of users with particular characteristics in a given spatial region, without using complex communication systems which exploit in particular central units for managing traffic. The proposed system advantageously operates in broadcasting mode on a region with a limited width defined by wireless short-range transmission.

Moreover, advantageously, the system according to the invention allows for assigning a characteristic signal to each personal terminal according to user's settings.

The proposed system is particularly advantageous in social applications for young people, as a cheap and simple instrument for communication between school pupils, or in aggregation places such as discotheques, concerts, meetings and other public events.

Obviously, though the basic idea of the invention remains the same, construction details and embodiments can widely vary with respect to what has been described and shown by mere way of example, however without leaving the framework of the invention.

The personal terminal can contain information other than user's preferences, for instance medical information useful in case of accident or illness.

It is also possible to implement into personal terminals a close proximity activation function, for instance by means of an inductive communication channel. This can be useful for instance in a pair-like mode, where pairs of personal terminals having the same characteristic frequency are provided for, which activate when they are at close distance or in contact.

Similarly, the contact function can be implemented into the “profile mode”, so that personal terminals activate when another personal terminal with corresponding profile is at close distance or in contact.

Said terminals in contact or at close distance are preferably to be integrated into small objects such as bracelets, pendants, rings or also pins used for piercing. Depending on size said terminals thus miniaturized can be supplied through batteries to be recharged from the electric system or with an automatic mechanism of storage of kinetic or vibrational energy.

Transmitting and receiving modules can operate for instance in bi-directional broadcasting mode, at frequencies of 315, 838 and 434 MHz for instance. The latter frequency band is particularly useful since it is already used for other civil applications such as remote controls, and cheap transceivers to be configured for the requirements of the invention are already available on the market.

According to a possible variant, the unit can be equipped with more than one transceiver, a low consumption, basically continuously operating transceiver for detecting the presence of other terminals and a higher consumption transceiver for managing communications with other terminals, respectively. It is thus possible to extend battery life, enabling a continuous detection of broadcast signals in the range of action of the terminal.

According to a further possible variant, transmitted messages or profiles can be of “disclosing” type, i.e. their content can be read only knowing a keyword associated thereto, so as to protect broadcast information.

According to a further possible variant, coupling by affinity can be conceived complementarily as coupling by incompatibility: in other words, two terminals can be configured so as to signal the presence of profiles and/or characteristics in profiles stored as incompatible. For instance, it is possible to signal—in particular via a specific signal—the presence of a supporter of an opposing soccer team, or an expired or non-renewed twin coupling can automatically result also in the generation of incompatibility characteristics between the two terminals whose twinning has not been renewed.

1. A system for monitoring and signaling users' presence in a spatial region (S), comprising a plurality of terminals (10, 10′) associated to said users, said terminals (10, 10′) comprising wireless transreceiving means (32) for transmitting and receiving in said spatial region (S) signals comprising at least a characteristic portion (ft, f′t; PK, PK′) associated to a user's characteristic information (P, P′), and modules (31) configured for managing and storing said user's characteristic information (P, P′) and for transmitting said characteristic information (P, P′) via said transreceiving means (32), characterized in that said transreceiving means (32) are configured for transmitting at short range (R) in broadcasting mode on said spatial region (S), and in that said terminals (10, 10′) further comprise means (11,16, 33,35) for signaling the reception of said signal characteristic portion (f′t; PK′) transmitted at short range (R) by a second terminal (10′) belonging to said plurality of terminals (10, 10′) and placed in said spatial region (S).

2. The system according to claim 1, characterized in that at least one of said terminals (45; 10″) associated to a user is associated to processing means (46,51) comprising a database for storing characteristic information (P, P′) of terminals (10, 10′) placed in the surrounding spatial region (S).

3. The system according to claim 2, characterized in that said terminal (45; 10″) is configured so as to interface in communication with a telecommunication network (52).

4. The system according to claim 2, characterized in that said plurality of terminals comprises one or more terminals fixedly associated (10″) to spatial positions and in communication with said communication system (52).

5. The system according to claim 3, characterized in that said database (51) can be accessed via remote terminals (53) through said communication network (52).

6. The system according to claim 1, characterized in that said terminal is associated to a mobile phone terminal.

7. The system according to claim 1, characterized in that said terminal (10, 10′; 10″; 45) is suitable for setting up communications with other terminals belonging to said plurality of terminals via alphanumeric messages and/or sound.

8. The system according to claim 7, characterized in that said alphanumeric messages and/or sound are protected by means of a keyword.

9. The system according to claim 1, characterized in that said terminal (45; 10″) or plurality of terminals (10, 10′) is configured for re-transmitting signals received in said spatial region (S).

10. The system according to claim 1, characterized in that said signal characteristic portion is represented by means of a characteristic frequency diagram (ft, f′t).

11. The system according to claim 1, characterized in that said signal characteristic portion (PK, PK′) is represented by means of characteristic numeric packets (PK, PK′).

12. The system according to claim 11, characterized in that said characteristic numeric packets (PK, PK′) comprise terminal characteristic fields (A, A′).

13. The system according to claim 11, characterized in that said characteristic numeric packets (PK, PK′) comprise profile characteristic fields (B1 . . . B7, B1′ . . . B7′).

14-16. (canceled)

17. The system according to claim 1, characterized in that said means (11, 16,33, 35) for signaling the reception of said signal characteristic portion (f′t, PK′) transmitted by a second terminal (10′) are configured for emitting a specific signal identifying said second terminal (10) depending on said terminal characteristic fields (A, A′) and/or profile characteristic fields (B1 . . . B7, B1′ . . . B7′).

18. The system according to claim 1, characterized in that said user's characteristic information (P, P′) comprise one or more pieces of information concerning personal preferences on various topics.

19. A method for monitoring and signaling a user's presence in a spatial region, in which terminals are associated to users, said terminals transreceiving in wireless mode in said spatial region (S) signals comprising a characteristic portion (ft, f′t ; PK, PK′) associated to a user's characteristic piece of information (P, P′), characterized in that said transreceiving operation in said spatial region (S) is carried out in short-ray broadcasting mode and the user is signaled the reception of said characteristic information in terminal (10).

20. The method according to claim 19, characterized in that said signaling operation is carried out if said received characteristic information (P′) corresponds wholly or partly to a characteristic information (P) stored in terminal (10).

21. The method according to claim 19, characterized in that it further comprises the following operations: storing one or more identifying codes (A′) included in the characteristic portions (ft, f′t ; PK, PK′) of second terminals (10′), and carrying out said operation involving signaling when characteristic portions coinciding wholly or partly with said identifiers (A′) are received, so as to define a “twin mode” for terminal coupling.

22. The method according to claim 19, characterized in that preference information (B1 . . . B7; B1′ . . . B7′) is inserted into said user's characteristic information (P, P′) and said operation involving signaling if received preference information (B1′ . . . B7′) corresponds wholly or partly to preference information (B1 . . . B7) stored in terminal (10) is carried out.

23. The method according to claim 19, characterized in that it further comprises the operation in which said characteristic portion (ft, f′t ; PK, PK′) is associated to said user's characteristic information (P, P′) by using as signal characteristic portion values of frequency (ft, ft) transmitted with given user's characteristic information (P, P′).

24. The method according to claim 19, characterized that it further comprises the operation in which specific information are searched for, in particular preference information (B1 . . . B7; B1′ . . . B7′), in the set of characteristic information (P, 45) available in spatial region (S).

25. The method according to claim 21, characterized in that said twin mode comprises the step of operating on actuating means (12,17) in a mutual way for storing said characteristic fields (A′) transmitted by a second terminal (10′) so as to implement a function of twin mutual connection.

26. (canceled)

27. The method according to claim 19, characterized in that said terminal (45; 10″) or plurality of terminals (10, 10′) is configured so as to re-transmit signals received in said spatial region (S).

28. A monitoring and signaling terminal configured so as to operate in the system for monitoring and signaling users' presence in a spatial region (S) according to claim 1.

29. The monitoring and signaling terminal of claim 28 comprising wireless transreceiving means (32) for transmitting and receiving in a spatial region (S) signals comprising at least a characteristic portion (ft, f′t ; PK, PK′) associated to a user's characteristic information (P, P′), and modules (31) configured so as to manage and store said user's characteristic information (P, P′) and transmit said characteristic information (P, pi) via said transreceiving means (32), characterized in that said transreceiving means (32) are configured so as to operate in proximity or contact detection in said spatial region (S), and in that said terminals (10, 10′) further comprise means (11,16, 33,35) for signaling the reception of said signal characteristic portion (f′t, PK′) transmitted by a second terminal (10′) belonging to said plurality of terminals (10, 10′) and placed in said proximity or contact spatial region (S).
